(19) United States
(12) Patent Application Publication
(10) Pub. No.: US 2010/0209000 A1
(43) Pub. Date: Aug. 19, 2010

(54) IMAGE PROCESSING APPARATUS FOR DETECTING COORDINATE POSITION OF CHARACTERISTIC PORTION OF FACE

(75) Inventors: Masaya Usui, Shiojiri-shi (JP); Kenji Matsuzaka, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/707,007

(22) Filed: Feb. 17, 2010

(30) Foreign Application Priority Data
Feb. 17, 2009 (JP) 2009-034041

(51) Int. Cl. G06K 9/46

(52) U.S. Cl. 382/195

(57) ABSTRACT

There is provided an image processing apparatus that is used for detecting a coordinate position of a characteristic portion of a face included in a target image.

Priority is claimed under 35 U.S.C. §119 to Japanese Application No. 2009-034041 filed on Feb. 17, 2009, which is hereby incorporated by reference in its entirety.

### BACKGROUND

1. Technical Field

The present invention relates to an image processing apparatus that detects the coordinate position of a characteristic portion of a face included in a target image.

2. Related Art

Recently, technology for detecting an image area that includes a face image as a face area from a target image has been known (JP-A-2000-149018). There are cases where incorrect detection occurs in which an image area not including a face image is incorrectly detected as a face area in the detecting of a face area. Accordingly, technology for calculating the reliability of face area detection, that is, an index indicating the reliability of the detected face area as an image area that includes an actual face image has been known. JP-A-2007-141107 is another example of related art.

However, there is room for calculating the reliability of the face area detection with higher accuracy.

### SUMMARY

An advantage of some aspects of the invention is that it provides technology for calculating the reliability of face area detection with high accuracy.

The invention employs the following aspects.

According to a first aspect of the invention, there is provided an image processing apparatus that is used for detecting a coordinate position of a characteristic portion of a face included in a target image. The image processing apparatus includes: a face area detecting unit that detects an image area including at least a part of a face image as a face area from the target image; a characteristic position detecting unit that sets a characteristic point, which is used for detecting the coordinate position of the characteristic portion, in the target image based on the face area, updates a setting position of the characteristic point so as to approach or be identical to the coordinate position of the characteristic portion by using a characteristic amount calculated based on a plurality of sample images including face images of which the coordinate positions of the characteristic portions are known, and detects the updated setting position as the coordinate position; and a face area reliability calculating unit that calculates face area reliability that represents reliability of a face image included in the face area detected by the face area detecting unit as an actual face image by using a differential amount that is calculated based on a difference between the updated setting position and the coordinate position.

According to the image processing apparatus of the first aspect, the face area reliability that is reliability of face area detection can be calculated with high accuracy by using a differential amount that is calculated based on a difference between the setting position of the characteristic point updated by the characteristic position detecting unit and the coordinate position of the characteristic portion of a face.

In the image processing apparatus of the first aspect, the face area reliability calculating unit may be configured to include: a characteristic portion reliability calculation section that calculates characteristic portion reliability that represents reliability of the detected coordinate position as the coordinate position of the characteristic portion of the face based on the differential amount; and a face area temporary reliability calculating section that calculates face area temporary reliability that represents reliability of the face image included in the detected face area as an actual face image based on a process of detecting the face area performed by the face area detecting unit. In such a case, the face area reliability is calculated by using the characteristic portion reliability and the face area temporary reliability. In the case, the face area reliability can be calculated with higher accuracy by using the characteristic portion reliability and the face area temporary reliability.

In the image processing apparatus of the first aspect, the face area reliability calculating unit may be configured to set an average value of the face area temporary reliability and the characteristic portion reliability as the face area reliability. In such a case, the face area reliability can be calculated with higher accuracy by setting an average value of the face area temporary reliability and the characteristic portion reliability as the face area reliability.

In the image processing apparatus of the first aspect, the differential amount may be a value based on an average shape image acquired by transforming a part of the target image based on the characteristic point set in the target image and an average face image that is generated based on the plurality of sample images. In such a case, the face area reliability can be calculated with higher accuracy by using a differential amount that is based on a differential value between the average shape image and the average face image.

In the image processing apparatus of the first aspect, the differential value may be represented by a difference between a pixel value of a pixel configuring the average shape image and a pixel value of a pixel of the average face image corresponding to the average shape image. In such a case, the face area reliability can be calculated with higher accuracy by using a differential value between a pixel value of a pixel that configures the average shape image and a pixel value of a pixel of the average face image corresponding to the average shape image for calculating the differential amount.

In the image processing apparatus of the first aspect, the differential amount may be a norm of the differential value. In such a case, the face area reliability can be calculated with higher accuracy by using the norm of the differential value.

In the image processing apparatus of the first aspect, the differential amount may be a norm of a corrected differential value that is acquired by applying coefficients to the differential values for each of a plurality of mesh areas that configures the average shape image. In such a case, the face area reliability can be calculated with higher accuracy by using the norm of the corrected differential value.

The image processing apparatus of the first aspect may be configured to further include a determination unit that determines whether a face image included in the face area detected by the face area detecting unit is an actual face image based on the face area reliability. In such a case, it can be accurately determined whether the face image included in the detected face area is an actual face image by using the face area reliability calculated by using the differential amount.

In the image processing apparatus of the first aspect, the characteristic amount may be a coefficient of a shape vector that can be acquired by performing a principal analysis for a coordinate vector of the characteristic portion that is included in the plurality of sample images. In such a case, the setting position of the characteristic point can be updated well by using the coefficient of the shape vector.

In the image processing apparatus of the first aspect, the characteristic portion may be some of an eyebrow, an eye, a nose, a mouth and a face line. In such a case, the face area reliability can be calculated with high accuracy by using a differential amount at the time when detecting the coordinate positions of some of the eyebrow, the eye, the nose, the mouth, and the face line.

In addition, the invention can be implemented in various forms and, for example, may be implemented as a printer, a digital still camera, a personal computer, a digital video camera, and the like. In addition, the invention can be implemented in the forms of an image processing method, an image processing apparatus, a method of detecting the positions of characteristic portions, an apparatus for detecting the positions of characteristic portions, a facial expression determining method, a facial expression determining apparatus, a computer program for implementing the functions of the above-described methods or apparatuses, a recording medium having the computer program recorded thereon, a data signal implemented in a carrier wave including the computer program, and the like.

### BRIEF DESCRIPTION OF THE DRAWINGS

The invention will be described with reference to the accompanying drawings, wherein like numbers reference like elements.

FIG. 1 is an explanatory diagram schematically showing the configuration of a printer as an image processing apparatus according to a first embodiment of the invention.

FIG. 2 is a flowchart showing the flow of a face characteristic position detecting process according to the first embodiment.

FIGS. 3A and 3B are explanatory diagrams illustrating the detecting of the face area FA from the target image OI.

FIG. 4 is an explanatory diagram illustrating filters that are used for calculating an evaluation value.

FIGS. 5A and 5B are explanatory diagrams illustrating a plurality of windows SW determined to be image areas corresponding to a face image as an example.

FIG. 6 is a flowchart showing the flow of an initial position setting process for characteristic points according to the first embodiment.

FIGS. 7A and 7B are explanatory diagrams showing an example of temporary setting positions of the characteristic points by changing the values of global parameters.

FIG. 8 is an explanatory diagram showing an example of an average shape images.

FIG. 9 is a flowchart showing the flow of a process for correcting a characteristic point setting position according to the first embodiment.

FIG. 10 is an explanatory diagram showing an example of the result of a face characteristic position detecting process.

FIG. 11 is an explanatory diagram showing relationship between the norm of a differential image and characteristic portion reliability as an example.

FIG. 12 is an explanatory diagram illustrating a second method of calculating the characteristic portion reliability.

FIGS. 13A and 13B are explanatory diagrams illustrating a third method of calculating the characteristic portion reliability.

FIG. 14 is a flowchart representing the flow of an AAM setting process.

FIG. 15 is an explanatory diagram showing an example of sample images.

FIG. 16 is an explanatory diagram representing an example of a method of setting the characteristic points of a sample image.

FIG. 17 is an explanatory diagram showing an example of the coordinates of the characteristic points set in the sample image.

FIGS. 18A and 18B are explanatory diagrams showing an example of an average shape.

FIGS. 19A and 19B are explanatory diagrams exemplifying relationship between a shape vector, a shape parameter, and a face shape.

FIG. 20 is an explanatory diagram showing an example of a warp W method for a sample image.

FIG. 21 is an explanatory diagram showing an example of an average face image.

FIG. 22 is a flowchart showing the flow of a face characteristic position detecting process according to a second embodiment of the invention.

FIG. 23 is an explanatory diagram exemplifying relationship between the norm of a differential image and characteristic portion reliability according to a modified example.

### DESCRIPTION OF EXEMPLARY EMBODIMENTS

Hereinafter, printers as one type of image processing apparatuses according to embodiments of the invention will be described with reference to the accompanying drawings.

### A. First Embodiment

### A1. Configuration of Image Processing Apparatus

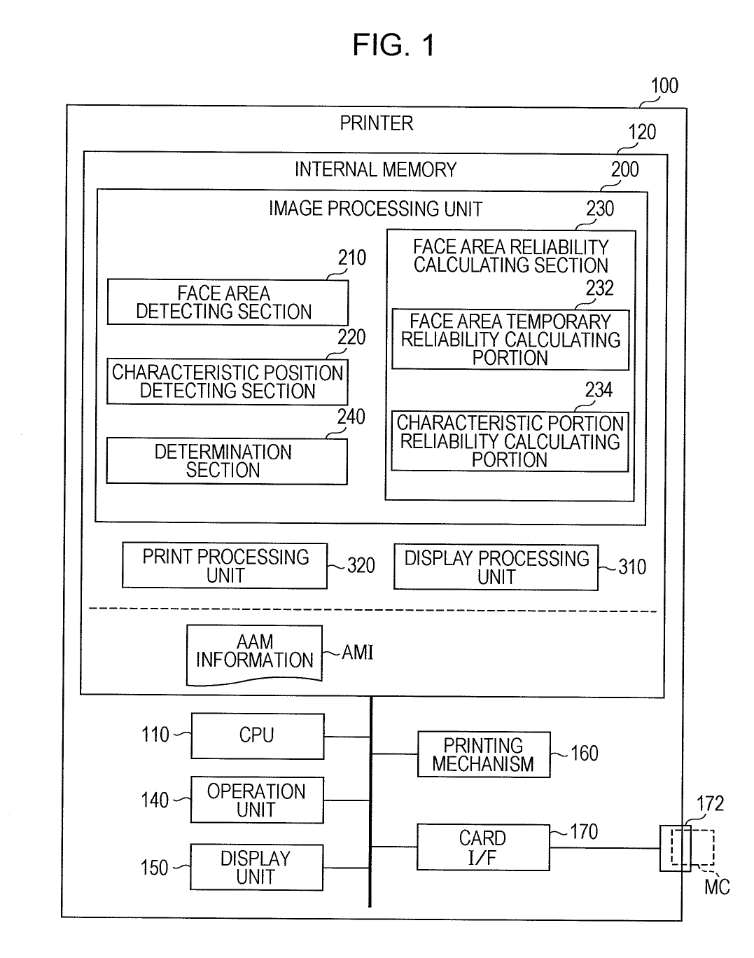

FIG. 1 is an explanatory diagram schematically showing the configuration of a printer 100 as an image processing apparatus according to a first embodiment of the invention. The printer 100 according to this embodiment is a color ink jet printer corresponding to so-called direct printing in which an image is printed based on image data that is acquired from a memory card MC or the like. The printer 100 includes a CPU 110 that controls each unit of the printer 100, an internal memory 120 that is configured by a ROM, and a RAM, an operation unit 140 that is configured by buttons or a touch panel, a display unit 150 that is configured by a liquid crystal display, a printing mechanism 160, and a card interface (card I/F) 170. In addition, the printer 100 may be configured to include an interface that is used for performing data communication with other devices (for example, a digital still camera or a personal computer). The constituent elements of the printer 100 are interconnected through a bus.

The printing mechanism 160 performs a printing operation based on print data. The card interface 170 is an interface that is used for exchanging data with a memory card MC inserted into a card slot 172. In this embodiment, an image file that includes the image data is stored in the memory card MC.

In the internal memory 120, an image processing unit 200, a display processing unit 310, and a print processing unit 320 are stored. The image processing unit 200 is a computer program and performs a face characteristic position detecting process by being executed by a CPU 110 under a predetermined operating system. The face characteristic detecting process is a process for detecting the positions of predetermined characteristic portions (for example, an eye area, a nose tip, and a face line) in a face image. The face characteristic detecting process will be described later in details. In addition, various functions are implemented as the CPU 110 also executes the display processing unit 310 and the printing processing unit 320.

The image processing unit 200 includes a face area detecting section 210, a characteristic position detecting section 220, a face area reliability calculating section 230, and a determination section 240 as program modules. The face area reliability calculating section 230 includes a face area temporary reliability calculating portion 232 and a characteristic portion reliability calculating portion 234. The functions of these units, sections, and portions will be described in details in a description of the face characteristic position detecting process to be described later.

The display processing unit 310 is a display driver that displays a process menu, a message, an image, or the like on the display unit 150 by controlling the display unit 150. The print processing unit 320 is a computer program that generates print data based on the image data and prints an image based on the print data by controlling the printing mechanism 160. The CPU 110 implements the functions of these units by reading out the above-described programs (the image processing unit 200, the display processing unit 310, and the print processing unit 320) from the internal memory 120 and executing the programs.

In addition, AAM information AMI, which is information on an active appearance model (also abbreviated as “AAM”) as a technique for modeling a visual event, is stored in the internal memory 120. The AAM information AMI is information that is set in advance in an AAM setting process to be described later and is referred to in the face characteristic position detecting process to be described later. The content of the AAM information AMI will be described in details in a description of the AAM setting process to be described later.

### A2. Face characteristic Position Detecting Process

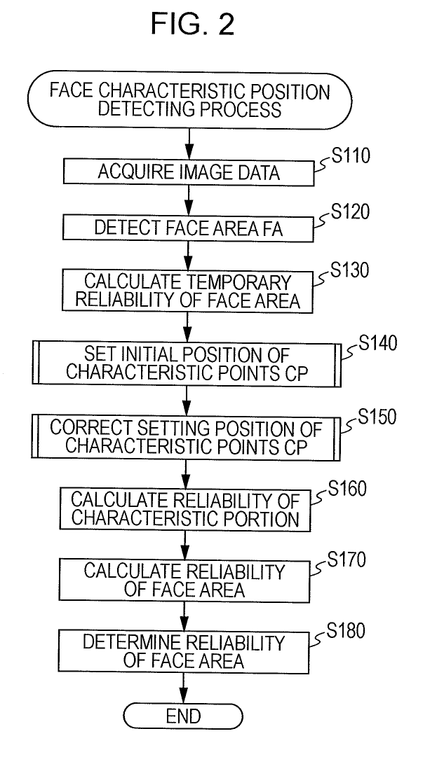

FIG. 2 is a flowchart showing the flow of the face characteristic position detecting process according to the first embodiment. The face characteristic position detecting process according to this embodiment is a process for detecting the positions of characteristic portions of a face image by using the AAM. In this embodiment, the AAM is to set a shape model that represents the shape of a face specified by the positions of the characteristic portions and a texture model that represents the “appearance” of an average shape through an statistical analysis on the positions (coordinates) and pixel values (for example, luminance values) of characteristic portions (for example, an eye area, a nose tip, and a face line) that are included in a plurality of sample images. By using such a model, modeling (synthesizing) of any arbitrary face image or detection of the positions of characteristic portions of a face included in an image can be performed.

In this embodiment, the AAM setting process for setting the shape model and the texture model that are used in the face characteristic position detecting process will be described later. In the AAM setting process, in sample images that are used for setting the shape model and the texture model, predetermined positions of person's facial organs and the contour of a person's face are set as the characteristic portions. In this embodiment, as the characteristic portions, 68 portions of a person's face that include predetermined positions on the eyebrows (for example, end points, four-division points, or the like; the same in description below), predetermined positions on the contour of the eyes, predetermined positions on contours of the bridge of the nose and the wings of the nose, predetermined positions on the contours of upper and lower lips, and predetermined positions on the contour (face line) of the face are set. Accordingly, by specifying the positions of 68 characteristic points CP that represent predetermined positions of a person's facial organs and the contour of a face through the face characteristic position detecting process of this embodiment, the positions of the characteristic portions are detected.

First, the image processing unit 200 (FIG. 1) acquires image data that represents a target image that is a target for the face characteristic position detecting process (Step S110). According to the printer 100 of this embodiment, when the memory card MC is inserted into the card slot 172, a thumbnail image of the image file that is stored in the memory card MC is displayed in the display unit 150. One or a plurality of images that is the target to be processed is selected by a user through the operation unit 140. The image processing unit 200 acquires an image file that includes the image data corresponding to one or the plurality of images that has been selected from the memory card MC and stores the image file in a predetermined area of the internal memory 120. Here, the acquired image data will be referred to as target image data, and an image represented by the target image data will be referred to as a target image OI.

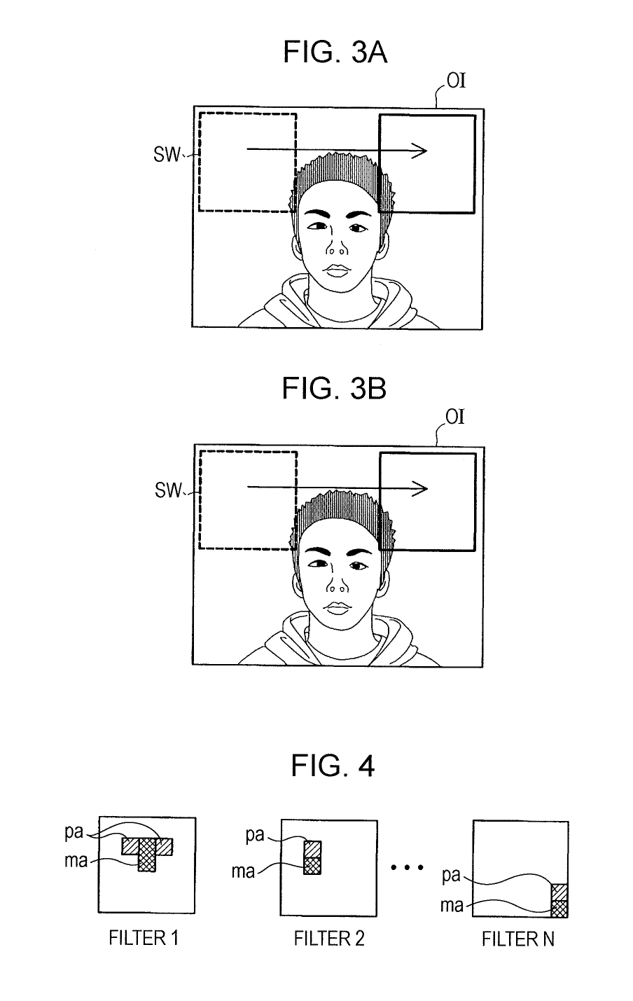

The face area detecting section 210 (FIG. 1) detects an image area that includes at least a part of a face image included in the target image OI as a face area FA (Step S120). FIGS. 3A and 3B are explanatory diagrams illustrating the detecting of the face area FA from the target image OI. As shown in FIG. 3A, the face area detecting section 210 sets one from among a plurality of windows SW having square shapes of various sizes defined in advance as the target image OI. The face area detecting section 210, as shown in FIG. 3B, allows the set window SW to scan on the target image OI. Then, when scanning of the window SW of one size is completed, the face area detecting section 210 sets a window SW of a different size on the target image OI, whereby sequentially performing scanning.

The face area detecting section 210 calculates an evaluation value that is used for face determination from the image area defined by the window SW in parallel with scanning of the window SW. The method of calculating the evaluation value is not particularly limited. However, in this embodiment, N filters (Filter 1 to Filter N) are used for calculating the evaluation value. FIG. 4 is an explanatory diagram illustrating filters that are used for calculating the evaluation value. The outer shape of each of the filters (Filter 1 to Filter N) has an aspect ratio that is the same as that of the window SW (that is, a square shape). In addition, in each filter, a plus area pa and a minus area ma are set. The face area detecting section 210 sequentially applies Filter X (here, X=1, 2, . . . , N) to the image area that is defined by the window SW so as to calculate basic evaluation values that become the base of the evaluation value. In particular, the basic evaluation value is a value acquired by subtracting a sum of luminance values of pixels included in an image area corresponding to the minus area ma of the filter X from a sum of luminance values of pixels included in an image area corresponding to the plus area pa of the filter X.

The face area detecting section 210 compares each calculated basic evaluation value with a threshold value that is set in correspondence with each basic evaluation value. In this embodiment, the face area detecting section 210 determines the image area defined by the window SW to be an image area corresponding to a face image for a filter for which the basic evaluation value is equal to or greater than the threshold value and sets “1” as the output value of the filter. On the other hand, for a filter for which the basic evaluation value is less than the threshold value, the face area detecting section 210 determines the image area that is defined by the window SW to be an image area that cannot be considered to be in correspondence with a face image and sets “0” as the output value of the filter. For each filter, a weighting factor is set, and a sum of multiplications of output values and weighting factors of all the filters is used as the evaluation value. The face area detecting section 210 determines whether an image area defined by the window SW is an image area corresponding to a face image by comparing the calculated evaluation value with the threshold value.

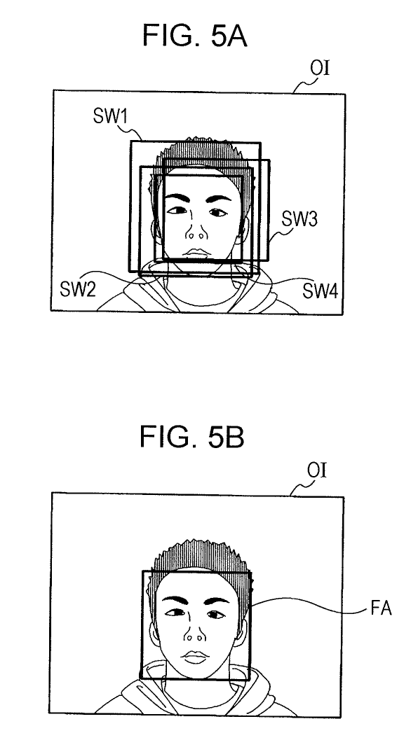

When there is a plurality of windows SW for which the image area defined by the windows SW are determined to be image areas corresponding to face images, the face area detecting section 210 detects one new window having the center located in average coordinates of predetermined points (for example, the center of each window SW) of the windows SW and having the size of an average size of the windows SW as the face area FA. FIGS. 5A and 5B are explanatory diagrams illustrating a plurality of windows SW determined to be image areas corresponding to a face image as an example. As shown in FIG. 5A, for example, in a case where image areas defined by four windows SW (SW1 to SW4) partially overlapping with one another are determined to be image areas corresponding to a face image, as shown in FIG. 5B, one window having the center located at the average coordinates of center coordinates of the four windows SW and having the size of an average size of the four windows SW is set as a face area FA.

The method of detecting a face area FA described above is only an example. Thus, various known face detecting techniques other than the above-described detection method can be used for detecting a face area FA. As the known face detecting techniques, for example, there are a technique using pattern matching, a technique using extraction of a skin-color area, a technique using learning data that is set by learning (for example, learning using a neural network, learning using boosting, learning using a support vector machine, or the like) using sample images, and the like.

The face area temporary reliability calculating portion 232 (FIG. 1) calculates a face area temporary reliability (Step S130). The face area temporary reliability is an index that is calculated based on the process of detecting a face area FA and indicates the reliability on the detection of a face area FA as an actual image area corresponding to a face area. In the face area FA detecting process, there is a possibility that an image area not corresponding to a face image, that is, an image area not including any face image or an image area including a part of a face image but not actually corresponding to a face image is detected as the face area FA incorrectly. The face area temporary reliability represents the reliability on the detection of the face area FA.

In this embodiment, a value acquired by dividing the number of overlapping windows by a maximum number of overlapping windows is used as the face area temporary reliability. Here, the number of overlapping windows is the number of windows SW that are referred when the face area FA is set, that is, the number of windows SW for which the image areas defined by the windows SW are determined to be image areas corresponding to face images. For example, when the face area FA shown in FIG. 5B is set, four windows SW (SW1 to SW4) shown in FIG. 5A are referred, and thus, the number of overlapping windows is four. In addition, the maximum number of overlapping windows is the number of windows SW that at least partially overlap with the face area FA, among all the windows SW disposed on the target image OI, when a face area FA is detected. The maximum number of overlapping windows is uniquely determined based on the movement pitches and the size changing pitches of the windows SW. Both the number of overlapping windows and the maximum number of overlapping windows can be calculated in the face area FA detecting process.

When the detected face area FA is an image area actually corresponding to a face area, there is high possibility that the image areas defined by a plurality of windows SW having the positions and the sizes close to one another are determined to be face areas corresponding to face images. On the other hand, when the detected face area FA is not an image area corresponding to a face image as a result of incorrect detection, there is high possibility that, even when an image area defined by a specific window SW is determined to be a face area corresponding to a face image, an image area defined by another window SW having the position and the size that are close to those of the specific window is determined not to be a face area corresponding to a face image. Accordingly, in this embodiment, the value acquired by dividing the number of overlapping windows by the maximum number of overlapping windows is used as the face area temporary reliability.

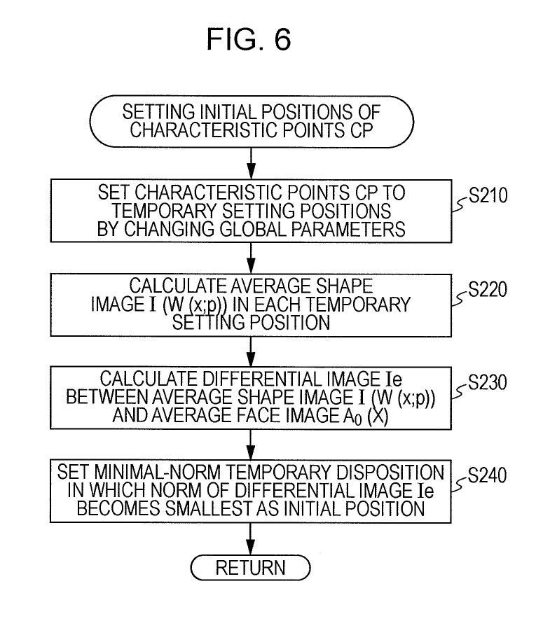

The characteristic position detecting section 220 (FIG. 1) sets the initial positions of the characteristic points CP of the target image OI (Step S140). FIG. 6 is a flowchart showing the flow of an initial position setting process for the characteristic points CP according to the first embodiment. The characteristic position detecting section 220 uses an average shape s₀ that is set in the AAM setting process for setting the initial positions of the characteristic points CP. The average shape s₀ is a model that represents an average face shape specified by each average position (average coordinates) of corresponding characteristic points CP of sample images. In this embodiment, the characteristic position detecting section 220 sets the characteristic points CP to temporary setting positions on the target image OI by variously changing the values of global parameters that represent the size, the tilt, and the positions (the position in the vertical direction and the position in the horizontal direction) of the face image with respect to the face area FA (Step S210).

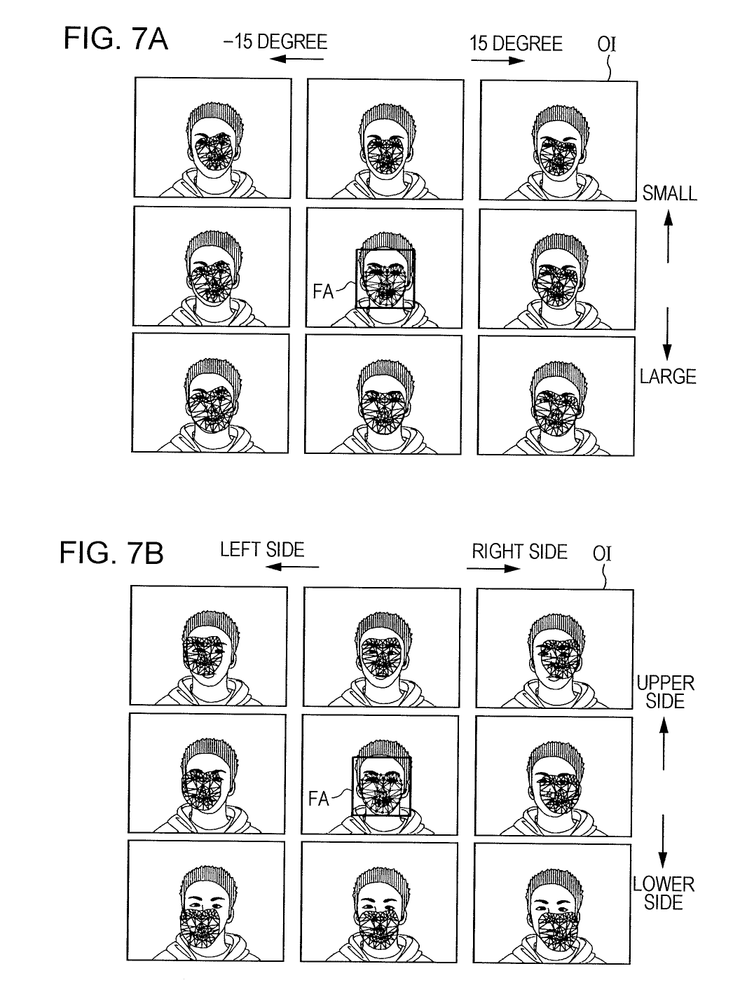

FIGS. 7A and 7B are explanatory diagrams showing an example of temporary setting positions of the characteristic points CP by changing the values of the global parameters. In FIGS. 7A and 7B, meshes fowled by joining the characteristic point CP and the characteristic point CP of the target image OI are shown. The characteristic position detecting section 220, as shown on the centers of FIGS. 7A and 7B, sets the temporary setting positions (hereinafter, also referred to as “reference temporary setting positions”) of the characteristic points CP such that the average shape s₀ is formed in the center portion of the face area FA.

The characteristic position detecting section 220 sets a plurality of the temporary setting positions by variously changing the values of the global parameters for the reference temporary setting position. The changing of the global parameters (the size, the tilt, the position in the vertical direction, and the position in the horizontal direction) corresponds to performing enlargement or reduction, a change in the tilt, and parallel movement of the meshes formed by the characteristic points CP with respect to the target image OI. Accordingly, the characteristic position detecting section 220, as shown in FIG. 7A, sets the temporary setting position (shown below or above the reference temporary setting position) for forming the meshes by enlarging or reducing the meshes of the reference temporary setting position by a predetermined scaling factor and the temporary setting position (shown on the right side or the left side of the diagram for the reference temporary setting position) for forming meshes of which the tilt is changed by rotating the meshes of the reference temporary setting position by a predetermined angle in the clockwise direction or the counter clockwise direction. In addition, the characteristic position detecting section 220 also sets the temporary setting position (shown on the upper left side, the lower left side, the upper right side, and the lower right side of the diagram for the reference temporary setting position) for forming the meshes acquired by performing a transformation combining enlargement or reduction and a change in the tilt for the meshes for the reference temporary setting position.

In addition, as shown in FIG. 7B, the characteristic position detecting section 220 sets the temporary setting position (shown above or below the diagram for the reference temporary setting position) for forming the meshes acquired by performing parallel movement for the meshes for the reference temporary setting position to the upper side or the lower side by a predetermined amount and the temporary setting position (shown on the left side and the right side of the diagram for the reference temporary setting position) for forming meshes acquired by performing parallel movement for the meshes for the reference temporary setting position to the left or right side. In addition, the characteristic position detecting section 220 sets the temporary setting position (shown on the upper left side, the lower left side, the upper right side, and the lower right side of the diagram for the reference temporary setting position) for forming meshes acquired by performing a transformation combining parallel movement to the upper side or the lower side and parallel movement to the left side or the right side for the meshes for the reference temporary setting position.

In addition, the characteristic position detecting section 220 also sets temporary setting positions acquired by performing parallel movement to the upper or lower side and to the left or right side for meshes, shown in FIG. 7B, for 8 temporary setting positions other than the reference temporary setting position shown in FIG. 7A. Accordingly, in this embodiment, a total of 81 types of the temporary setting positions including 80 (=3×3×3×3−1) types of temporary setting positions that are set by using combinations of known three-level values for each of four global parameters (the size, the tilt, the position in the vertical direction, and the position in the horizontal direction) and the reference temporary setting position.

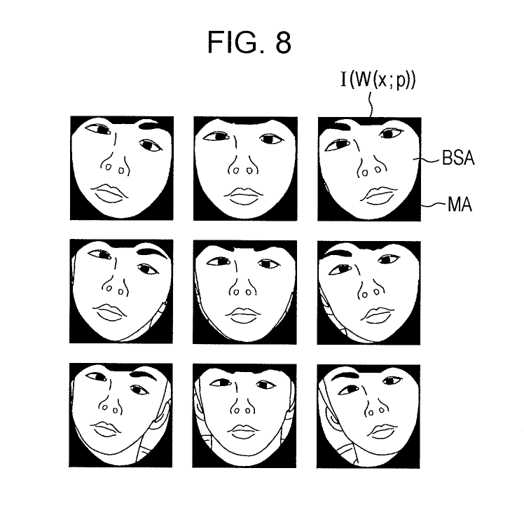

The characteristic position detecting section 220 generates an average shape image I(W(x;p)) corresponding to each temporary setting position that has been set (Step S220). FIG. 8 is an explanatory diagram showing an example of the average shape images I(W(x;p)). The average shape image I(W(x;p)) is calculated by performing a transformation for which the disposition of the characteristic points CP in an input image is identical to that of the characteristic points CP in the average shape s₀.

The transformation for calculating the average shape image I(W(x;p)), similarly to the transformation for calculating the sample images SIw in the AAM setting process, is performed by the warp W that is a set of affine transformations for each triangle area TA. In particular, an average shape area BSA that is an area surround by straight lines joining characteristic points CP (characteristic points CP corresponding to the face line, the eyebrows, and a region between the eyebrows) located on the outer periphery is specified by characteristic points CP disposed in the target image OI. Then, by performing an affine transformation for each triangle area TA of the average shape area BSA of the target image OI, the average shape image I(W(x;p)) is calculated. In this embodiment, the average shape image I(W(w;p)), similarly to the average face image A₀(x) that is an image in which an average face of the sample images after the warp W are represented, is configured by an average shape area BSA and a mask area MA and is calculated as an image having the same size as the average face image A₀(x). The warp W, the average shape area BSA, the average face image A₀(x), and the mask area MA will be described in details in the AAM setting process.

Here, a set of pixels located in the average shape area BSA of the average shape s₀ is denoted by a pixel group x. The pixel group in the image (the average shape area BSA of the target image OI) before performing the warp W that corresponds to the pixel group x in the image (the face image having the average shape s₀) after performing the warp W is denoted by W(x;p). Since the average shape image is an image that is configured by the luminance values of each pixel group W(x;p) in the average shape area BSA of the target image OI, the average shape image is denoted by I(W(x;p)). In FIG. 8, nine average shape images I(W(x;p)) corresponding to nine temporary setting positions shown in FIG. 7A are shown.

The characteristic position detecting section 220 calculates a differential image Ie between the average shape image I(W(x;p)) corresponding to each temporary setting position and the average face image A₀(x) set in the AAM setting process (Step S230). The differential image Ie is a difference between pixel values of the average shape image I(W(x;p)) and the average face image A₀(x) and is also referred to as a differential value in this embodiment. Since the differential image Ie does not appear when the setting positions of the characteristic points CP are identical to the positions of the characteristic portions, the differential image Ie represents a difference between the setting positions of the characteristic points CP and the positions of the characteristic portions. In this embodiment, since 81 types of the temporary setting positions of the characteristic points CP are set, the characteristic position detecting section 220 calculates 81 differential images Ie.

The characteristic position detecting section 220 calculates a norm from the pixel values of the differential images Ie and sets a temporary setting position (hereinafter, also referred to as a minimal-norm temporary setting position) corresponding to the differential image Ie having norm of the smallest value as the initial position of the characteristic points CP in the target image OI (Step S240). In this embodiment, the pixel value used for calculating the norm may be either a luminance value or an RGB value. In this embodiment, the “norm of the differential images Ie” corresponds to a “differential amount” according to an embodiment of the invention. Accordingly, the initial position setting process for the characteristic points CP is completed.

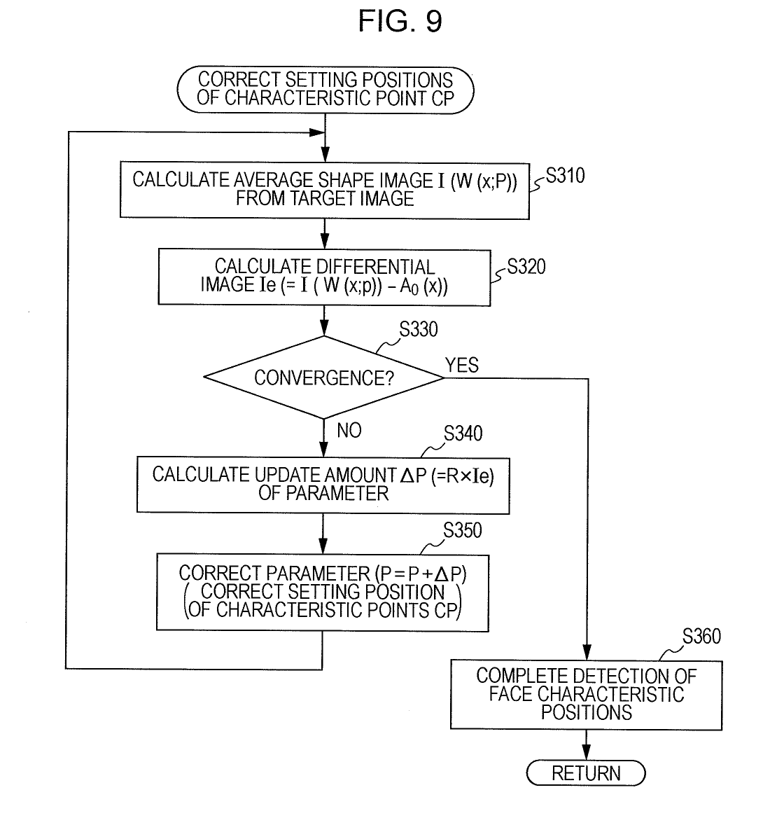

When the initial position setting process for the characteristic points CP is completed, the characteristic position detecting section 220 corrects the set position of the characteristic points CP in the target image OI (Step S150). FIG. 9 is a flowchart showing the flow of a process for correcting the characteristic point CP setting position according to the first embodiment.

The characteristic position detecting section 220 calculates an average shape image I(W(x;p)) from the target image OI (Step S310). The method of calculating the average shape image I(W(x;p)) is the same as that in Step S220 of the initial position setting process for the characteristic points CP.

The characteristic position detecting section 220 calculates a differential image Ie between the average shape image I(W(x;p)) and the average face image A₀(x) (Step S320). The characteristic position detecting section 220 determines whether the process for correcting the characteristic point CP setting position converges based on the differential image Ie (Step S330). The characteristic position detecting section 220 calculates the norm of the differential image Ie. When the value of the norm is smaller than a threshold value set in advance, the characteristic position detecting section 220 determines convergence. On the other hand, when the value of the norm is equal to or lager than the threshold value set in advance, the characteristic position detecting section 220 determines no convergence.

Alternatively, the characteristic position detecting section 220 may be configured to determine convergence for a case where the value of the norm of the calculated differential image Ie is smaller than that calculated in Step S320 at the previous time and determine no convergence for a case where the value of the norm is equal to or larger than the previous value. Furthermore, the characteristic position detecting section 220 may be configured to determine on the convergence by combining the determination on the basis of the threshold value and the determination on the basis of the comparison with the previous value. For example, the characteristic position detecting section 220 may be configured to determine only for a case where the value of the calculated norm is smaller than the threshold value and is smaller than the previous value and to determine no convergence for other cases.

When no convergence is determined in the above-described convergence determination in Step S330, the characteristic position detecting section 220 calculates the update amount ΔP of the parameter (Step S340). The update amount ΔP represents the amount of change in the values of the four global parameters (the overall size, the tilt, the position in the X-direction, and the position in the Y-direction) and n shape parameters pᵢ calculated in the AAM setting process. In addition, right after setting the characteristic points CP to the initial position, the values determined in the initial position setting process for the characteristic points CP are set to the global parameters. In addition, since a difference between the initial position of the characteristic points CP and the set position of the characteristic points CP of the average shape s₀ at this moment is limited to a difference of the overall size, the tilt, and the positions, all the values of the shape parameters pᵢ of the shape model are zero.

The update amount ΔP of the parameters is calculated by using the following Equation (1). In other words, the update amount ΔP of the parameters is product of an update matrix R and the difference image Ie.

ΔP=R×Ie Equation (1)

The update matrix R represented in Equation (1) is a matrix of M rows×N columns that is set by learning in advance for calculating the update amount ΔP of the parameters based on the differential image Ie and is stored in the internal memory 120 as the AAM information AMI (FIG. 1). In this embodiment, the number M of the rows of the update matrix R is identical to a sum (4+n) of the number (4) of the global parameters and the number (n) of the shape parameters pᵢ, and the number N of the columns is identical to the number (56 pixels×56 pixels−number of pixels included in the mask area MA) within the average shape area BSA of the average face image A₀(x) (FIGS. 6A and 6B). The update matrix R is calculated by using the following Equations (2) and (3).

$$\begin{matrix}R = {H}^{- 1} \sum {[ ∇ {A}_{0} \frac{\partial W}{\partial P} ]}^{T} & Equation ( 2 ) \\ H = \sum {[ ∇ {A}_{0} \frac{\partial W}{\partial P} ]}^{T} [ ∇ {A}_{0} \frac{\partial W}{\partial P} ] & Equation ( 3 )\end{matrix}$$

The equations (4) and (5) are known in the “Active Appearance Models Revisited” issued by lain et al. The characteristic position detecting section 220 updates the parameters (four global parameters and n shape parameters pᵢ) based on the calculated update amount ΔP of the parameters (Step S350). Accordingly, the setting position of the characteristic points CP in the target image OI is updated. The characteristic position detecting section 220 updates the parameters such that the norm of the differential image Ie decreases. After update of the parameters is performed, again, the average shape image I(W(x;p)) is calculated (Step S310) from the target image OI for which the set position of the characteristic points CP has been corrected (Step S310), the differential image Ie is calculated (Step S320), and a convergence determination is made based on the differential image Ie (Step S330). In a case where no convergence is determined in the convergence determination performed again, additionally, the update amount ΔP of the parameters is calculated based on the differential image Ie (Step S340), and correction of the set position of the characteristic points CP by updating the parameters is performed (Step S350).

When the process from Step S310 to Step S350 shown in FIG. 9 is repeatedly performed, the positions of the characteristic points CP corresponding to the characteristic portions of the target image OI approach the positions of actual characteristic portions as a whole. Then, the convergence is determined in the convergence determination (Step S330) at a time point. When the convergence is determined in the convergence determination, the face characteristic position detecting process is completed (Step S360). The set position of the characteristic points CP specified by the values of the global parameters and the shape parameters pᵢ, which are set at that moment, is determined to be the final setting position of the characteristic points CP in the target image OI. There are cases where the positions of the characteristic points CP corresponding to the characteristic portions in the target image OI become identical to the positions of the actual characteristic portions by repeating the process of Step S310 to Step to S350.

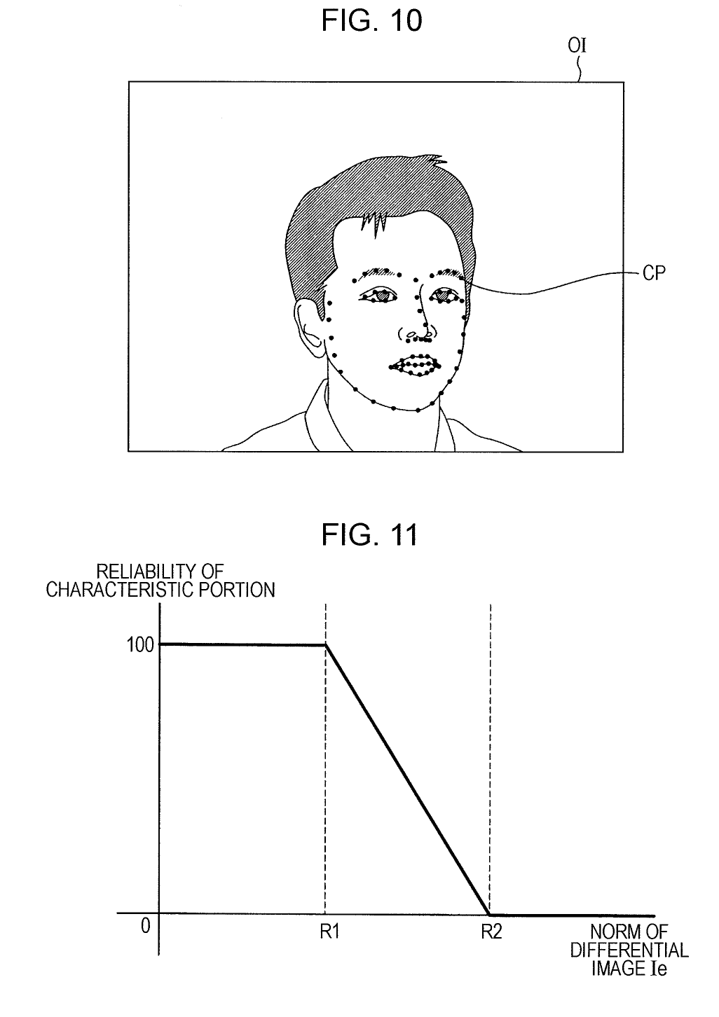

FIG. 10 is an explanatory diagram showing an example of the result of the face characteristic position detecting process. In FIG. 10, the set position of the characteristic points CP that is finally determined for the target image OI is shown. In accordance with the set position of the characteristic positions CP, the positions of the characteristic portions (person's facial organs (the eyebrows, the eyes, the nose, and the mouth) and predetermined positions in the contour of a face) of the target image OI are specified. Accordingly, the shapes and the positions of the person's facial organs and the contour and the shape of the face of the target image OI can be detected.

When the initial position setting process for the characteristic points CP is completed, the characteristic portion reliability calculating portion 234 (FIG. 1) calculates the characteristic portion reliability (Step S160). The characteristic portion reliability is an index that is calculated based on the norm of the converged differential image Ie and represents the reliability on the detection of the position of the characteristic portion as an actual position of the characteristic portion of a face. Similarly to the face area FA detecting process, in the face characteristic position detecting process, there is a possibility that a position that is not a position of a characteristic portion of a face, that is, a position not overlapping with an actual position of a characteristic portion of a face at all or a position that partially overlaps with the position of the actual characteristic portion of a face but does not accurately correspond to the position is incorrectly detected as the position of the characteristic portion of a face. The characteristic portion reliability represents the reliability on the detection of the position of the characteristic portion of a face.

FIG. 11 is an explanatory diagram showing relationship between the norm of a differential image and the characteristic portion reliability as an example. In this embodiment, by using the pre-defined correspondence graph shown in FIG. 11, the characteristic portion reliability is uniquely calculated from the norm of a differential image Ie. By using the correspondence graph shown in FIG. 11, the scale of the norm of differential image Ie is converted such that the value of the characteristic portion reliability is in the range of 0 to 100. Here, when the characteristic portion reliability is “0”, it represents that there is high possibility that the position of the characteristic portion of a face is not correctly detected. On the other hand, when the reliability is “100”, it represents that there is high possibility that the position of the characteristic portion of a face is correctly detected. In addition, in order to eliminate the influence of lighting and the like on the norm of the differential image Ie, a normalization process may be performed, so that the average values and variance values of the luminance values of each pixel included in the average shape image I(W(x;p)) and the pixel values (luminance values) of the average face image A₀(x) are uniform.

After calculating the characteristic portion reliability, the face area reliability calculating section 230 (FIG. 1) calculates the face area reliability (Step S170). The face area reliability is an index that is calculated based on the face area temporary reliability calculated in Step S130 and the characteristic portion reliability calculated in the previous Step S160 and, similarly to the face area temporary reliability, represents the reliability on the detection of the face area FA as an image area corresponding to an actual face image. In this embodiment, the face area reliability calculating section 230 calculates an average value of the calculated face area temporary reliability and the characteristic portion reliability as the face area reliability.

When the face area reliability is calculated, the determination section 240 (FIG. 1) determines whether the detected face area FA is an image area corresponding to an actual face image based on the face area reliability (Step S180). In this embodiment, the determination section 240 performs the determination by comparing a threshold value set in advance with the face area reliability. Accordingly, the face characteristic position detecting process is completed.

The print processing unit 320 generates print data of the target image OI for which the face area reliability is calculated. In particular, the print processing unit 320 generates the print data by performing a color conversion process for adjusting pixel values of pixels to the ink used by the printer 100, a halftone process for representing the gray scales of pixels after the color conversion process by distribution of dots, a rasterization process for changing the data sequence of the image data, for which the halftone process has been performed, in the order to be transmitted to the printer 100, and the like for the target image OI. The printing mechanism 160 prints the target image OI for which the face area reliability has been calculated based on the print data generated by the print processing unit 320.

In addition, the print processing unit 320 does not necessarily need to generate the print data of the target image OI for which the face area reliability has been calculated. For example, a configuration in which whether to generate the print data is determined based on the value of the face area reliability calculated in Step S170 or the result of determination made in Step S180 may be used. In addition, it may be configured that the face area reliability or the result of the determination is displayed in the display unit 150, and the print data is generated based on user's selection whether to perform printing. Furthermore, the print processing unit 320 is not limited to generating the print data of the target image OI. Thus, the print processing unit 320 may generate the print data of an image, for which a predetermined process such as face transformation or correction for the shade of a face has been performed based on the shape and the position of the detected facial organ or the contour and the shape of a face. In addition, the printing mechanism 160 may print an image for which a process such as a face transformation or correction for the shade of a face has been performed based on the print data that is generated by the print processing unit 320.

### A3. Other Methods of Calculating Reliability

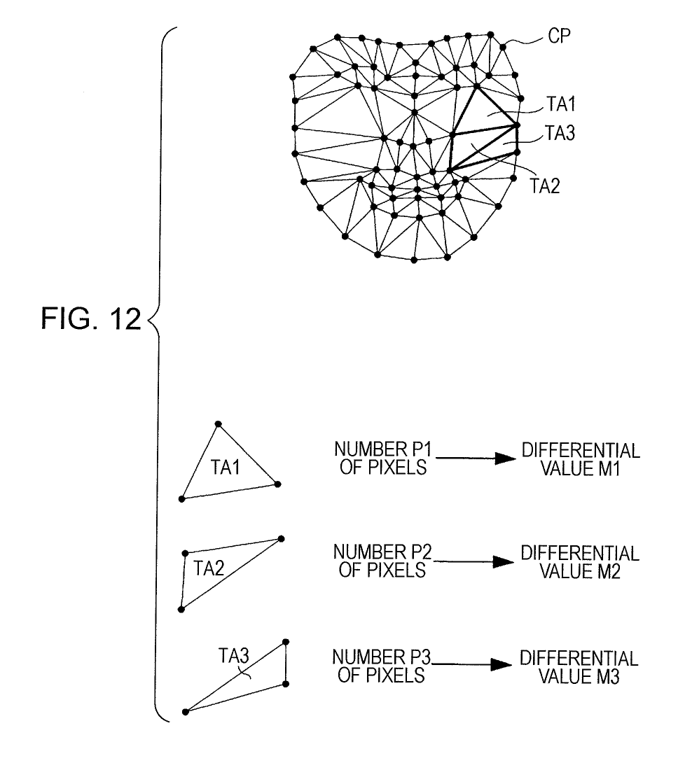

The method of calculating the characteristic portion reliability calculated in the above-described Step S160 may be changed in various forms. FIG. 12 is an explanatory diagram illustrating a second method of calculating the characteristic portion reliability. According to the second method, the characteristic portion reliability is calculated by using the norm of corrected differential values that are acquired by applying weighting factors to each differential value included in the differential image Ie after convergence for each triangle area TA. In particular, the corrected differential value Mr is calculated for the differential image Ie by applying weighting coefficients (α, β, γ, . . . ) to the differential values Mj (here, j=1, 2, 3, . . . , 107) for each of 107 triangle areas TA(j) (here, j=1, 2, 3, . . . , 107) that are formed by 68 characteristic points CP. In other words, the corrected differential value Mr can be represented as Mr=α×M1+β×M2+γ×M3+ . . . . The differential values M1, M2, and M3 for triangle areas TA1, TA2, and TA3 shown in FIG. 12 are sets of differential values for the pixels included in the corresponding area. The differential values M1, M2, and M3 represent differential values for the number P1, P2, and P3 of pixels. By applying a correspondence diagram, for example, as shown in FIG. 11 to the norm of the calculated corrected differential value Mr, the characteristic portion reliability can be calculated. By using the corrected differential value Mr, the characteristic portion reliability can be calculated by changing the contribution rate of the difference (differential portion) of each of a plurality of areas included in a face area to the reliability. For example, in a case where the reliability of the position detected as the eye is an important factor in detection of face characteristic portions, by increasing the value of a coefficient applied to a triangle area including the eye area, the influence of the magnitude of the differential value of the eye area on the characteristic portion reliability can be increased. In the second method the “norm of the corrected differential value Mr” corresponds to a “differential amount” according to an embodiment of the invention.

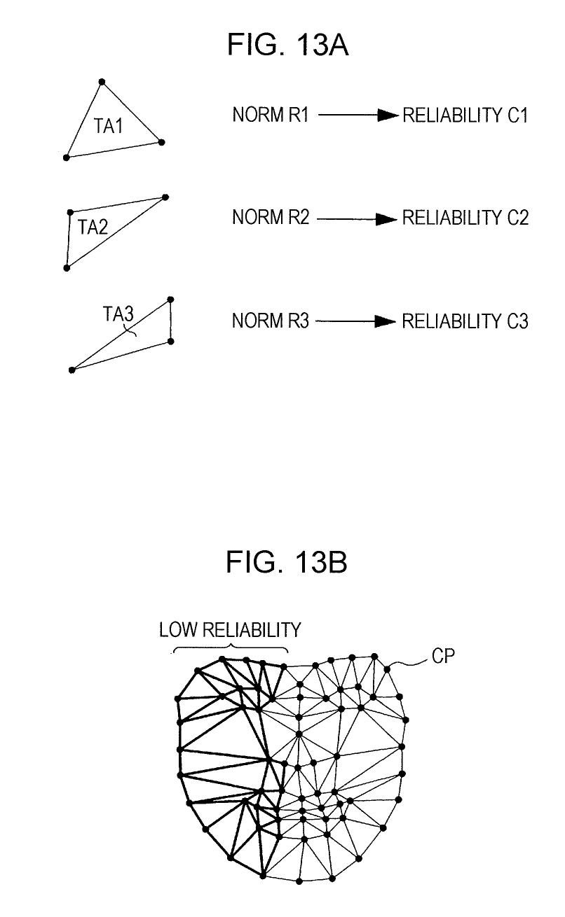

FIGS. 13A and 13B are explanatory diagrams illustrating a third method of calculating the characteristic portion reliability. According to the third method, the characteristic portion reliability is calculated for each triangle area TA that configures the differential image Ie. In particular, as shown in FIG. 13A, for the above-described triangle areas TA1, TA2, and TA3, norms R1, R2, and R3 are calculated from differential values M1, M2, and M3, and by applying a correspondence diagram for the reliability to the norms R1, R2, and R3, the characteristic portion reliability C1, C2, and C3 for each triangle area TA can be calculated. By calculating the characteristic portion reliability for each triangle area TA, as shown in FIG. 13B, for example, in a case where the characteristic portion reliability is low for all the triangle areas TA located on the left side in a face image, it can be estimated that there is the influence of a shadow on the left half side. In addition, based on the distribution of the characteristic portion reliability, whether or not the photographing condition is good, whether a face faces the upper or lower side or the right or left side, and the like can be estimated. In addition, a process in which only triangle areas TA having high characteristic portion reliability are set as sampling targets for skin-color correction or a process in which correction is performed only for an area having high characteristic portion reliability can be performed.

### A4. AAM Setting Process

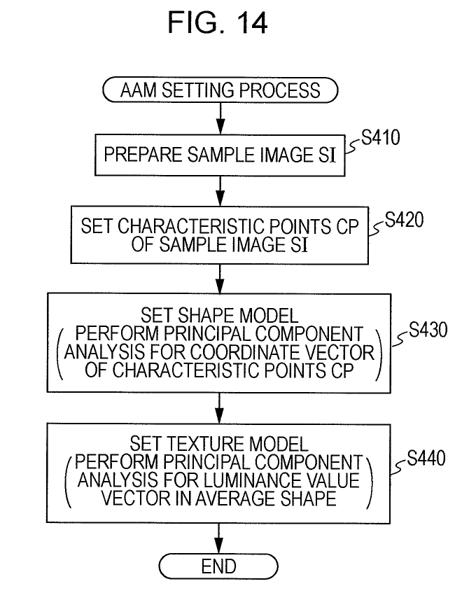

FIG. 14 is a flowchart representing the flow of the AAM setting process. The AAM setting process is a process for setting a shape model and a texture model that are used in image modeling. In this embodiment, the AAM setting process is performed by a user.

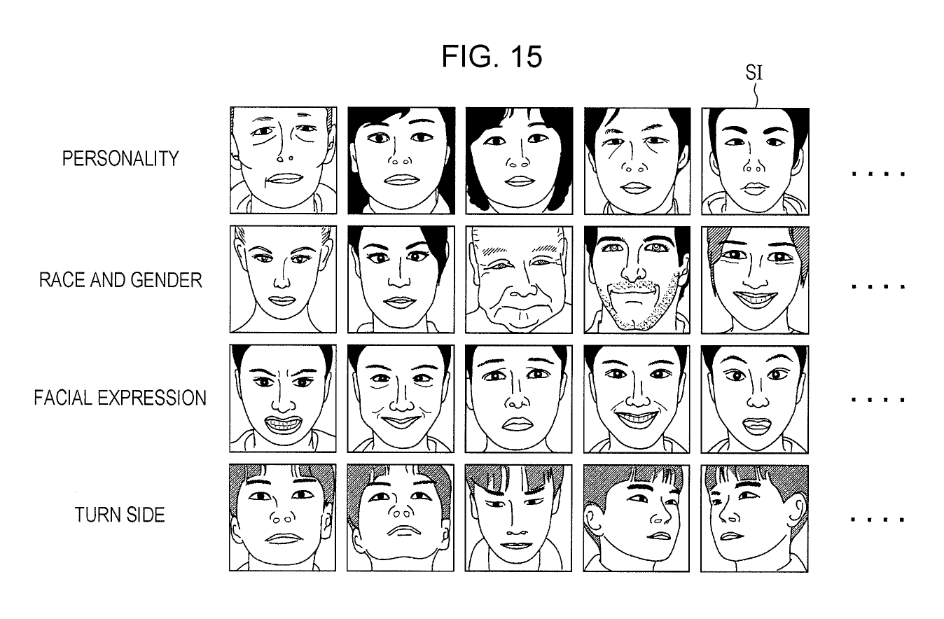

First, the user prepares a plurality images that includes person's faces as sample images SI (Step S410). FIG. 15 is an explanatory diagram showing an example of the sample images SI. As represented in FIG. 15, the sample images SI are prepared such that images having different attributes for various attributes such as personality, race, gender, facial expression (anger, laughter, troubled, surprise, or the like), and a direction (front-side turn, upward turn, downward turn, right-side turn, left-side turn, or the like). When the sample images SI are prepared in such a manner, all the face images can be modeled with high accuracy by the AAM. Accordingly, the face characteristic position detecting process (to be described later) can be performed with high accuracy for all the face images. The sample images SI are also referred to as face images for learning.

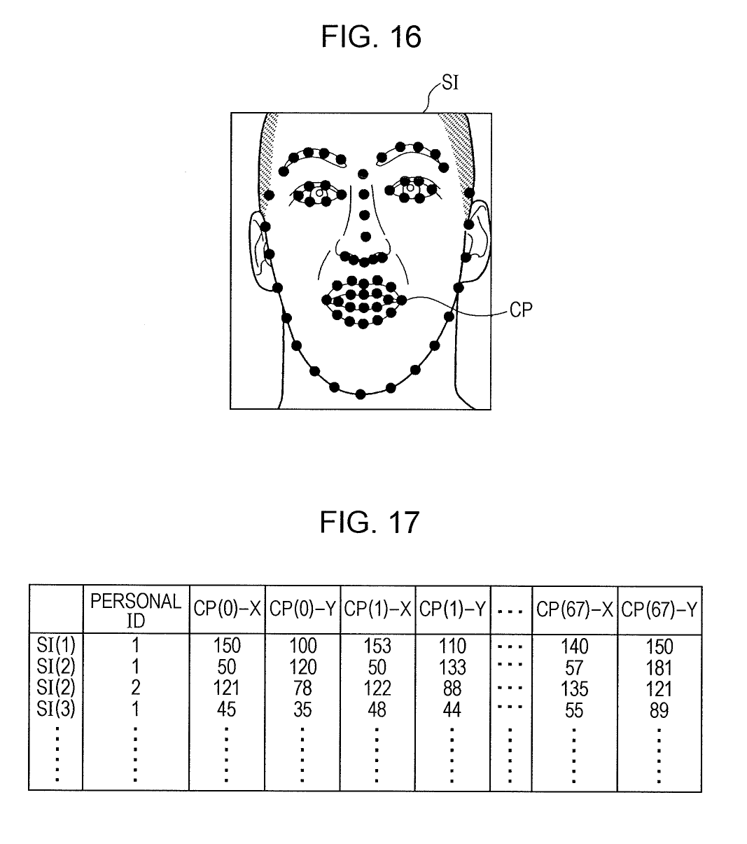

Then, the characteristic points CP are set for a face image that is included in each sample image SI (Step S420). FIG. 16 is an explanatory diagram representing an example of a method of setting the characteristic points CP of a sample image SI. In this embodiment, as described above, predetermined positions in the facial organs (the eyebrow, the eye, the nose, and the mouth) and the contour of a face are set as the predetermined characteristic portions. As shown in FIG. 16, the characteristic points CP are set (disposed) in positions that represent 68 characteristic portions of each sample image SI designated by a user for each sample image SI. The characteristic points CP set as described above correspond to the characteristic portions, and accordingly it can be represented that the disposition of the characteristic points CP in a face image specifies the shape of the face.

The position of each characteristic point CP in a sample image SI is specified by coordinates. FIG. 17 is an explanatory diagram showing an example of the coordinates of the characteristic points CP set in the sample image SI. In FIG. 17, SI(j) (j=1, 2, 3 . . . ) represents each sample image SI, and CP(k) (k=0, 1, 67) represents each characteristic point CP. In addition, CP(k)-X represents the X coordinate of the characteristic point CP(k), and CP(k)−Y represents the Y coordinate of the characteristic point CP(k). As the coordinates of the characteristic point CP, coordinates set by using a predetermined reference point (for example, a lower left point in an image) in a sample image SI that is normalized for the face size, the face tilt (a tilt within the image surface), and the positions of the face in the X direction and the Y direction as the origin point are used. In addition, in this embodiment, a case where a plurality of person's images is included in one sample image SI is allowed (for example, two faces are included in a sample image SI(2)), and the persons included in one sample image SI are specified by personal IDs.

Subsequently, the user sets the shape model of the AAM (Step S430). In particular, the face shape s that is specified by the positions of the characteristic points CP is modeled by the following Equation (4) by performing a principal component analysis for a coordinate vector (see FIGS. 5A and 5B) that is configured by the coordinates (X coordinates and Y coordinates) of 68 characteristic points CP in each sample image SI. In addition, the shape model is also called a disposition model of characteristic points CP.

$$s = {s}_{0} + {\sum }_{i = 1}^{n} {p}_{i} {s}_{i} \qquad Equation ( 4 )$$

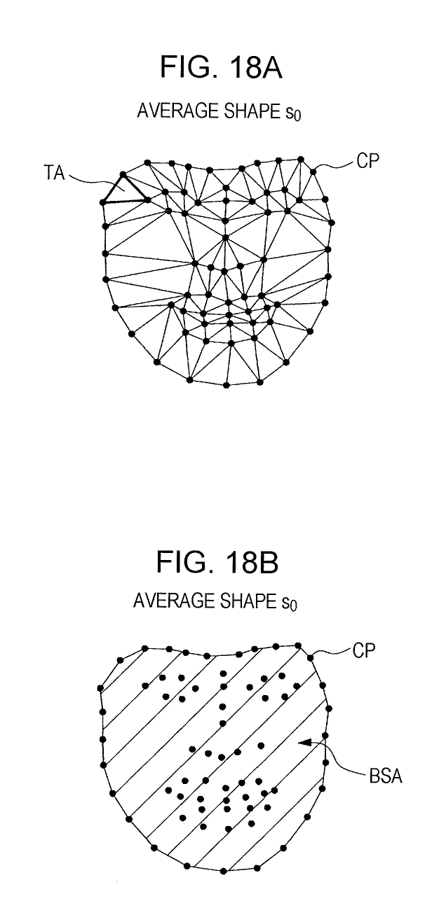

In the above-described Equation (4), s₀ is an average shape. FIGS. 18A and 18B are explanatory diagrams showing an example of the average shape s₀. As shown in FIGS. 18A and 18B, the average shape s₀ is a model that represents an average face shape that is specified by average positions (average coordinates) of each characteristic point of the sample image SI. In addition, an area (denoted by being hatched in FIG. 18B) surrounded by straight lines enclosing characteristic points CP (characteristic points CP corresponding to the face line, the eyebrows, and a region between the eyebrows) located on the outer periphery of the average shape s₀ is referred to as an “average shape area BSA”. The average shape s₀ is set such that, as shown in FIG. 18A, a plurality of triangle areas TA having the characteristic points CP as their vertexes divides the average shape area BSA into mesh shapes.

In the above-described Equation (4) representing a shape model, sᵢ is a shape vector, pᵢ is a shape parameter that represents the weight of the shape vector sᵢ. The shape vector sᵢ is a vector that represents the characteristics of the face shape s and is an eigenvector corresponding to an i-th principal vector that is acquired by performing principal component analysis. As shown in the above-described Equation (4), in the shape model according to this embodiment, a face shape s that represents the disposition of the characteristic points CP is modeled as a sum of an average shape s₀ and a linear combination of n shape vectors sᵢ. By appropriately setting the shape parameter pᵢ for the shape model, the face shapes s in all the images can be reproduced.

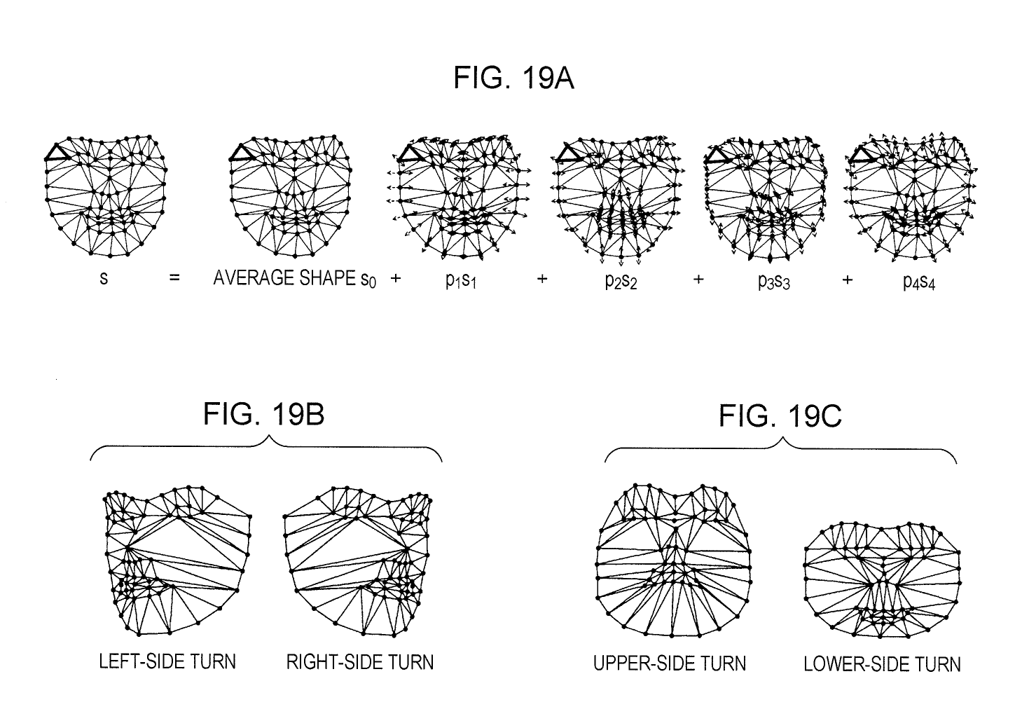

FIGS. 19A and 19B are explanatory diagrams exemplifying relationship between the shape vector sᵢ, the shape parameter pᵢ, and the face shape s. As shown in FIG. 19A, in order to specify a face shape s, n (n=4 in FIG. 19) eigenvectors that are set based on the accumulated contribution rates in the order of eigenvectors corresponding to principal components having higher contribution rates are used as the shape vectors sᵢ. Each of the shape vectors sᵢ, as denoted by arrows shown in FIG. 19A, corresponds to the moving direction and the amount of movement of each characteristic point CP. In this embodiment, a first shape vector s₁ that corresponds to a first principal component having the highest contribution rate is a vector that is approximately correlated with the horizontal appearance of a face. Accordingly, by changing the value of the shape parameter p₁, as shown in FIG. 19B, the turn of the face shape s in the horizontal direction is changed. A second shape vector s₂ corresponding to a second principal component that has the second highest contribution rate is a vector that is approximately correlated with the vertical appearance of a face. Accordingly, by changing the value of the shape parameter p₂, as shown in FIG. 19C, the turn of the face shape s in the vertical direction is changed. In addition, a third shape vector s₃ corresponding to a third principal component having the third highest contribution rate is a vector that is approximately correlated with the aspect ratio of a face shape, and a fourth shape vector s₄ corresponding to a fourth principal component having the fourth highest contribution rate is a vector that is approximately correlated with the degree of opening of a mouth. As described above, the values of the shape parameters represent characteristics of a face image such as a facial expression and the turn of the face. The “shape parameter” according to this embodiment correspond to “characteristic amount” according to an embodiment of the invention.

In addition, the average shape s₀ and the shape vector sᵢ that are set in the shape model setting step (Step S430) is stored in the internal memory 120 as the AAM information AMI (FIG. 1).

Subsequently, a texture model of the AAM is set (Step S440). In particular, first, image transformation (“warp W”) is performed for each sample image SI, so that set positions of the characteristic points CP in the sample image SI are identical to those of the characteristic points CP in the average shape s₀.

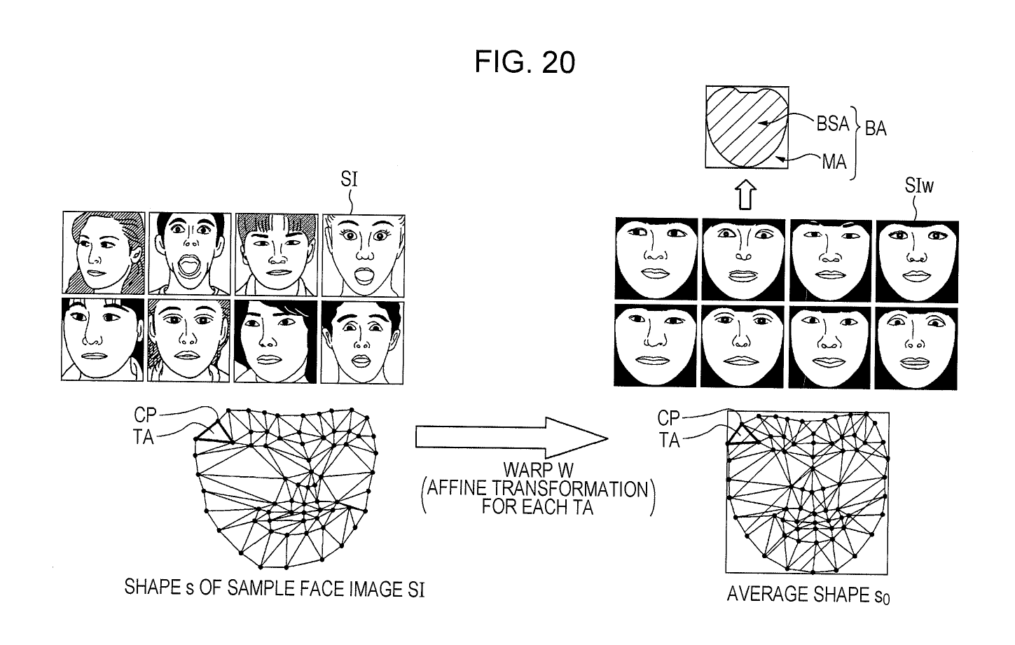

FIG. 20 is an explanatory diagram showing an example of a warp W method for a sample image SI. For each sample image SI, similar to the average shape s₀, a plurality of triangle areas TA that divides an area surrounded by the characteristic points CP located on the outer periphery into mesh shapes is set. The warp W is an affine transformation set for each of the plurality of triangle areas TA. In other words, in the warp W, an image of triangle areas TA in a sample image SI is transformed into an image of corresponding triangle areas TA in the average shape s₀ by using the affine transformation method. By using the warp W, a sample image SIw having the same set positions as those of the characteristic points CP of the average shape s₀ is generated.

In addition, each sample image SIw is generated as an image in which an area (“mask area MA”) other than the average shape area BSA is masked by using the rectangular range including the average shape area BSA (denoted by being hatched in FIG. 20) as the outer periphery. In addition, each sample image SIw is normalized, for example, as an image having the size of 56 pixels×56 pixels.

Next, the texture (also referred to as an “appearance”) A(x) of a face is modeled by using the following Equation (5) by performing principal component analysis for a luminance value vector that is configured by luminance values for each pixel group x of each sample image SIw. In addition, the pixel group x is a set of pixels that are located in the average shape area BSA.

$$A ( x ) = {A}_{0} ( x ) + {\sum }_{i = 1}^{m} {λ}_{i} {A}_{i} ( x ) \qquad Equation ( 5 )$$

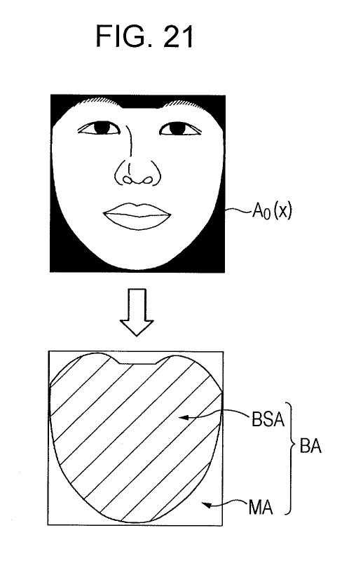

In the above-described Equation (5), A₀(x) is an average face image. FIG. 21 is an explanatory diagram showing an example of the average face image A₀(x). The average face image A₀(x) is an average face of sample images SIw after the warp W. In other words, the average face image A₀(x) is an image that is calculated by taking an average of pixel values (luminance values) of pixel groups x located within the average shape area BSA of the sample image SIw. Accordingly, the average face image A₀(x) is a model that represents the texture of an average face in the average face shape. In addition, the average face image A₀(x), similarly to the sample image SIw, is configured by an average shape area BSA and a mask area MA and, for example, is calculated as an image having the size of 56 pixels×56 pixels.

In the above-described Equation (5) representing a texture model, Aᵢ(x) is a texture vector, λᵢ is a texture parameter that represents the weight of the texture vector Aᵢ(x). The texture vector, λᵢ(x) is a vector that represents the characteristics of the texture Aᵢ(x) of a face. In particular, the texture vector Aᵢ(x) is an eigenvector corresponding to an i-th principal component that is acquired by performing principal component analysis. In other words, m eigenvectors set based on the accumulated contribution rates in the order of the eigenvectors corresponding to principal components having the higher contribution rate are used as a texture vector Aᵢ(x). In this embodiment, the first texture vector Aᵢ(x) corresponding to the first principal component having the highest contribution rate is a vector that is approximately correlated with a change in the color of a face (may be perceived as a difference in gender).

As shown in the above-described Equation (5), in the texture model according to this embodiment, the face texture A(x) representing the outer appearance of a face is modeled as a sum of the average face image A₀(x) and a linear combination of m texture vectors Aᵢ(x). By appropriately setting the texture parameter λᵢ in the texture model, the face textures A(x) for all the images can be reproduced. In addition, the average face image A₀(x) and the texture vector Aᵢ(x) that are set in the texture model setting step (Step S440 in FIG. 2) are stored in the internal memory 120 as the AAM information AMI (FIG. 1).

By performing the above-described AAM setting process, a shape model that models a face shape and a texture model that models a face texture are set. By combining the shape model and the texture model that have been set, that is, by performing transformation (an inverse transformation of the warp W shown in FIG. 20) from the average shape s₀ into a shape s for the synthesized texture A(x), the shapes and the textures of all the face images can be reproduced.

As described above, according to the image processing apparatus of the first embodiment, the face area reliability is calculated by using the differential amount. Accordingly, the face area reliability can be calculated with higher accuracy.

In particular, the norm of the differential image Ie is calculated based on a differential value between the average shape image I(W(x;p)) and the average face image A₀(x) that represent a difference between the position of the characteristic portion specified by the characteristic point CP and the position of the actual characteristic portion of a face. Accordingly, when the value of the norm of the differential images Ie converges to around 0 by updating the setting position of the characteristic points CP by using the update amount ΔP of the parameters, there is high possibility that the detected face area FA includes an actual face image. On the other hand, when the value of the norm of the differential images Ie does not converge and the value of the norm is maintained to be great even by updating the parameters, there is high possibility that an actual face image is not included in the detected face area FA. Accordingly, by using the norm of the differential images Ie, the face area reliability can be calculated with higher accuracy.

In addition, the norm of the corrected differential values Mr is calculated based on the differential image Ie. Accordingly, the norm of the corrected differential values Mr becomes a value corresponding to a difference between the position of the characteristic portion specified by the characteristic point CP and the position of the actual characteristic portion of a face. Accordingly, by using the corrected differential value Mr, as in the case where the norm of the differential image Ie is used, the face area reliability can be calculated with higher accuracy. In addition, by using the corrected differential value Mr, the characteristic portion reliability can be calculated by changing the contribution rate of each difference (differential portion) among a plurality of areas included in a face area to the reliability.

According to the image processing apparatus of the first embodiment, the face area reliability is calculated by using the characteristic portion reliability and the face area temporary reliability. Accordingly, the face area reliability can be calculated with higher accuracy. In particular, the face area reliability can be calculated by using two indices of the characteristic portion reliability calculated based on the differential amount and the face area temporary reliability calculated based on the face area FA detecting process. Therefore, the face area reliability can be calculated with higher accuracy.

According to the image processing apparatus of the first embodiment, the average value of the face area temporary reliability and the characteristic portion reliability is used as the face area reliability. Accordingly, the face area reliability can be calculated with higher accuracy. In particular, even when the face area FA is an image area corresponding to an actual face image, in a case where the face area temporary reliability is calculated to be low such as a case where the number of overlapping windows is small or a case where the maximum number of overlapping windows is great, the detected face area FA may be determined not to be an image area corresponding to an actual face image. However, in such a case, by using the average value of the face area temporary reliability and the characteristic portion reliability, the value of the face area reliability can be increased, whereby incorrect determination can be suppressed.

According to the printer 100 of the first embodiment, the target image OI of which the face area reliability is calculated can be printed. Accordingly, any arbitrary image can be selected so as to be printed based on the result of determination for the face area. In addition, an image for which a predetermined process such as a face transformation or shade correction for a face has been performed based on the shapes and the positions of facial organs or the contour and the shape of a face that have been detected can be printed. Accordingly, after the face transformation or the face-shade correction, or the like is performed for a specific face image, the face can be printed.

### B. Second Embodiment

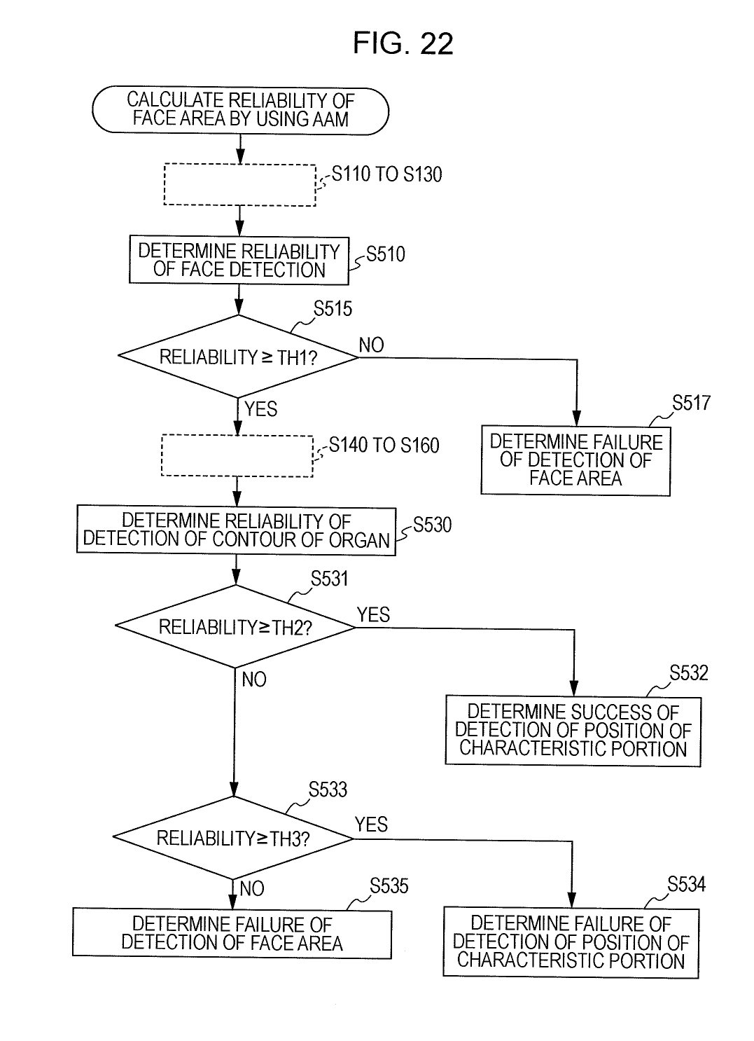

FIG. 22 is a flowchart showing the flow of a face characteristic position detecting process according to a second embodiment of the invention. In the first embodiment, an average value of the face area temporary reliability and the characteristic portion reliability is calculated as the face area reliability. However, in the second embodiment, either the face area temporary reliability or the characteristic portion reliability is used as the face area reliability in accordance with values of the face area temporary reliability and the characteristic portion reliability. As shown in FIG. 22, as in the first embodiment, acquisition of image data (Step S110), detection of a face area FA (Step S120), and calculation of the face area temporary reliability (Step S130) are performed.

The determination section 240 determines the face area temporary reliability (Step S510). In particular, the determination section 240 compares the face area temporary reliability with a threshold value TH1. When the face area temporary reliability is less than the threshold value TH1 (Step S515: NO), the determination section 240 determines that the detected face area FA is not an image area corresponding to an actual face image (Step S517). In other words, in such a case, detection of a face area is determined to have failed. On the other hand, when the face area reliability is equal to or more than the threshold value TH1 (Step S515: YES), as in the first embodiment, the initial position setting for the characteristic points CP (Step S140), correction for the characteristic point CP setting position (Step S150), and calculation of the characteristic portion reliability (Step S160) are performed.

When the characteristic portion reliability is calculated, the determination section 240 determines the characteristic portion reliability (Step S530). In particular, the determination section 240 compares the characteristic portion reliability with a threshold value TH2. When the characteristic portion reliability is equal to or more than the threshold value TH2 (Step S531: YES), the determination section 240 determines that the position of the detected characteristic portion is the position of an actual characteristic portion of a face (Step S532). In other words, in such a case, detection of a characteristic portion is determined to have succeeded.

On the other hand, when the face area reliability is less than the threshold value TH2 (Step S531: NO), the determination section 240 compares the characteristic portion reliability with a threshold value TH3 (Step S533). The threshold value TH3 has a value less than that of the threshold value TH2. When the characteristic portion reliability is equal to or more than the threshold value TH3 (Step S533: YES), the determination section 240 determines that the position of the detected characteristic potion is not the position of an actual characteristic portion of a face (Step S534). In other words, detection of the characteristic portion is determined to have failed.

On the other hand, when the characteristic portion reliability is less than the threshold value TH3 (Step S533: NO), the determination section 240 determines that the detected face area FA is not an image area corresponding to an actual face image (Step S535). In other words, the detection of a face area is determined to have failed.

According to the second embodiment, the face area reliability that represents the reliability of detection of a face image included in a face area as an actual face image does not need to be a value calculated by using the face area temporary reliability and the characteristic portion reliability all the time. Thus, the face area temporary reliability may be the face area reliability or the characteristic portion reliability may be the face area reliability in accordance with the value of the face area temporary reliability or the characteristic portion reliability. In other words, according to the second embodiment, when the face area reliability is less than the threshold value TH1 (Step S515: NO), it is determined that the detected face area FA is not an image area corresponding to an actual face image. In such a case, the face area temporary reliability is used as the face area reliability. In addition, when the characteristic portion reliability is less than the threshold value TH3 (Step S533: NO), it is determined that the detected face area FA is not an image area corresponding to an actual face image. In such a case, the characteristic portion reliability is used as the face area reliability. According to the second embodiment, whether the detected face area FA is an image area corresponding to an actual face image can be determined with high accuracy. In other words, the face area reliability having high accuracy can be calculated.

### C. Modified Examples

Furthermore, the invention is not limited to the above-described embodiments or examples. Thus, various embodiments can be performed without departing from the scope of the base idea of the invention. For example, the following modifications can be made.

### C1. Modified Example 1

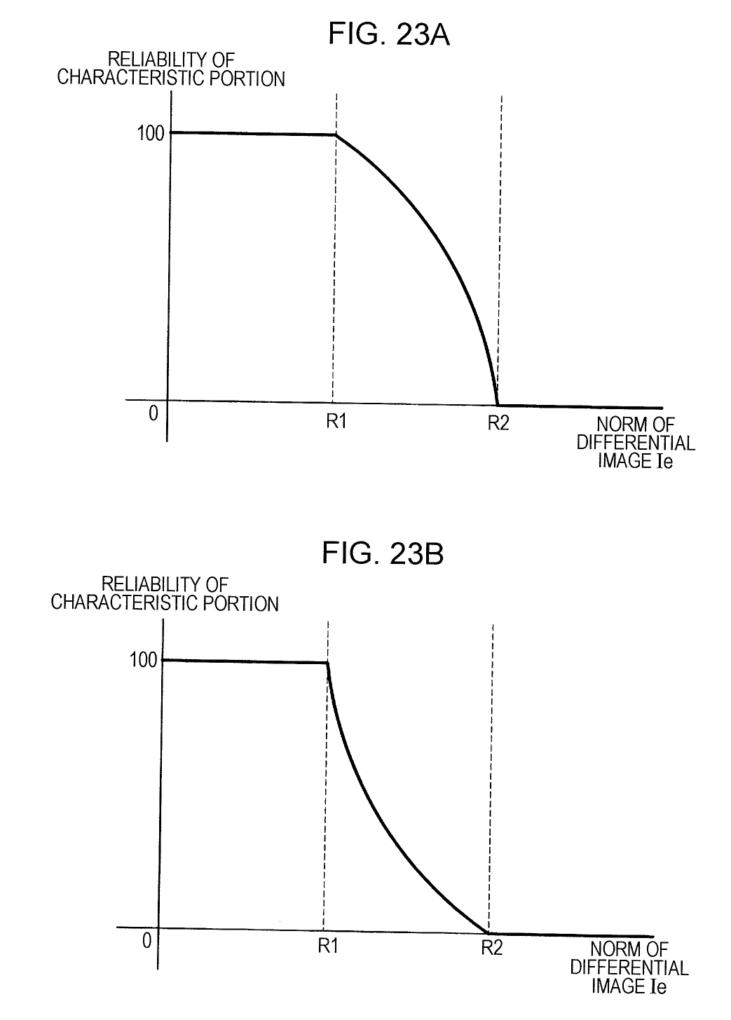

FIGS. 23A and 23B are explanatory diagrams showing the relationship between the norm of a differential image and the characteristic portion reliability according to a modified example, as an example. In this embodiment, referring to FIG. 11, linear correspondence relationship between the norm of a differential image Ie and the characteristic portion reliability is represented. However, the correspondence relationship between the differential image Ie and the characteristic portion reliability can be arbitrarily set. For example, as shown in FIGS. 23A and 23B, a part of the correspondence relationship may be non-linear. Alternatively, the correspondence relationship may have any other form.

### C2. Modified Example 2

In the above-described embodiment, the determination is made on the basis of the face area reliability by using the determination section 240. However, a configuration in which the determination section 240 is not included and only the face area reliability is output may be used.

### C3. Modified Example 3

In the above-described embodiment, an average value of the face area temporary reliability and the characteristic portion reliability is used as the face area reliability. However, the invention is not limited thereto. Thus, any arbitrary weighted value may be used as the face area reliability.

### C4: Modified Example 4

By using the face area detecting and the characteristic portion reliability of the above-described embodiment, face authentication can be performed by using a frame having high characteristic portion reliability when a face area FA is consecutively acquired from a motion picture in real time. Accordingly, the accuracy of face authentication can be improved.

### C5. Modified Example 5

In this embodiment, the sample image SI is only an example, and the number and the types of images used as the sample images SI may be set arbitrarily. In addition, the predetermined characteristic portions of a face that are represented in the positions of the characteristic points CP in this embodiment are only an example. Thus, some of the characteristic portions set in the above-described embodiments can be omitted, or other portions may be used as the characteristic portions.

In addition, in this embodiment, the texture model is set by performing principal component analysis for the luminance value vector that is configured by luminance values for each pixel group x of the sample image SIw. However, the texture mode may be set by performing principal component analysis for index values (for example, RGB values) other than the luminance values that represent the texture of the face image.

In addition, in this embodiment, the size of the average face image A₀(x) is not limited to 56 pixels×56 pixels and may be configured to be different. In addition, the average face image A₀(x) needs not to include the mask area MA (FIG. 8) and may be configured by only the average shape area BSA. Furthermore, instead of the average face image A₀(x), a different reference face image that is set based on statistical analysis for the sample images SI may be used.

In addition, in this embodiment, the shape model and the texture model that use the AAM are set. However, the shape model and the texture model may be set by using any other modeling technique (for example, a technique called a Morphable Model or a technique called an Active Blob).

In addition, in this embodiment, the image stored in the memory card MC is configured as the target image OI. However, for example, the target image OI may be an image that is acquired through a network. In addition, the detection mode information may be acquired through a network.

In addition, in this embodiment, the image processing performed by using the printer 100 as an image processing apparatus has been described. However, a part of or the whole processing may be configured to be performed by an image processing apparatus of any other type such as a personal computer, a digital still camera, or a digital video camera. In addition, the printer 100 is not limited to an ink jet printer and may be a printer of any other type such as a laser printer or a sublimation printer.

In this embodiment, a part of the configuration that is implemented by hardware may be replaced by software. On the contrary, a part of the configuration implemented by software may be replaced by hardware.

In addition, in a case where a part of or the entire function according to an embodiment of the invention is implemented by software (computer program), the software may be provided in a form being stored on a computer-readable recording medium. The “computer-readable recording medium” in an embodiment of the invention is not limited to a portable recording medium such as a flexible disk or a CD-ROM and includes various types of internal memory devices such a RAM and a ROM and an external memory device of a computer such as a hard disk that is fixed to a computer.

What is claimed is:

1. An image processing apparatus that is used for detecting a coordinate position of a characteristic portion of a face included in a target image, the image processing apparatus comprising:
a face area detecting unit that detects an image area including at least a part of a face image as a face area from the target image;
a characteristic position detecting unit that sets a characteristic point, which is used for detecting the coordinate position of the characteristic portion, in the target image based on the face area, updates a setting position of the characteristic point so as to approach or be identical to the coordinate position of the characteristic portion by using a characteristic amount calculated based on a plurality of sample images including face images of which the coordinate positions of the characteristic portions are known, and detects the updated setting position as the coordinate position; and
a face area reliability calculating unit that calculates face area reliability that represents reliability of a face image included in the face area detected by the face area detecting unit as an actual face image by using a differential amount that is calculated based on a difference between the updated setting position and the coordinate position.

2. The image processing apparatus according to claim 1,
wherein the face area reliability calculating unit includes:
a characteristic portion reliability calculation section that calculates characteristic portion reliability that represents reliability of the detected coordinate position as the coordinate position of the characteristic portion of the face based on the differential amount; and
a face area temporary reliability calculating section that calculates face area temporary reliability that represents reliability of the face image included in the detected face area as an actual face image based on a process of detecting the face area performed by the face area detecting unit, and
wherein the face area reliability is calculated by using the characteristic portion reliability and the face area temporary reliability.

3. The image processing apparatus according to claim 2, wherein the face area reliability calculating unit sets an average value of the face area temporary reliability and the characteristic portion reliability as the face area reliability.

4. The image processing apparatus according to claim 3, wherein the differential amount is a value based on an average shape image acquired by transforming a part of the target image based on the characteristic point set in the target image and an average face image that is generated based on the plurality of sample images.

5. The image processing apparatus according to claim 4, wherein the differential value is represented by a difference between a pixel value of a pixel configuring the average shape image and a pixel value of a pixel of the average face image corresponding to the average shape image.

6. The image processing apparatus according to claim 5, wherein the differential amount is a norm of the differential value.

7. The image processing apparatus according to claim 5, wherein the differential amount is a norm of a corrected differential value that is acquired by applying coefficients to the differential values for each of a plurality of mesh areas that configures the average shape image.

8. The image processing apparatus according to claim 7, further comprising a determination unit that determines whether a face image included in the face area detected by the face area detecting unit is an actual face image based on the face area reliability.

9. The image processing apparatus according claim 8, wherein the characteristic amount is a coefficient of a shape vector that can be acquired by performing a principal analysis for a coordinate vector of the characteristic portion that is included in the plurality of sample images.

10. An image processing method for detecting a coordinate position of a characteristic portion of a face included in a target image, using a computer comprising:
detecting an image area including at least a part of a face image as a face area from the target image;
setting a characteristic point, which is used for detecting the coordinate position of the characteristic portion, in the target image based on the face area, updating a setting position of the characteristic point so as to approach or be identical to the coordinate position of the characteristic portion by using a characteristic amount calculated based on a plurality of sample images including face images of which the coordinate positions of the characteristic portions are known, and detecting the updated setting position as the coordinate position; and
calculating face area reliability that represents reliability of a face image included in the face area detected by a face area detecting unit as an actual face image by using a differential amount that is calculated based on a difference between the updated setting position and the coordinate position.

11. A computer program used for image processing of detecting a coordinate position of a characteristic portion of a face included in a target image, the computer program implements in a computer functions comprising:
a function for detecting an image area including at least a part of a face image as a face area from the target image;
a function for setting a characteristic point, which is used for detecting the coordinate position of the characteristic portion, in the target image based on the face area, updating a setting position of the characteristic point so as to approach or be identical to the coordinate position of the characteristic portion by using a characteristic amount calculated based on a plurality of sample images including face images of which the coordinate positions of the characteristic portions are known, and detecting the updated setting position as the coordinate position; and
a function for calculating face area reliability that represents reliability of a face image included in the face area detected by a face area detecting unit as an actual face image by using a differential amount that is calculated based on a difference between the updated setting position and the coordinate position.
